(19) United States
(12) Patent Application Publication
(10) Pub. No.: US 2016/0106081 A1
(43) Pub. Date: Apr. 21, 2016

(54) Angled frame bladed fishing lure

(71) Applicant: David Lynn Thorne, Kayesville, UT (US)

(72) Inventor: David Lynn Thorne, Kaysville, UT (US)

(21) Appl. No.: 14/757,354

(22) Filed: Dec. 21, 2015

Related U.S. Application Data
(63) Continuation-in-part of application No. 14/545,547, filed on May 19, 2015.
Application No. 14/545,547 is a continuation-in-part of application No. 14/544,787, filed on Feb. 18, 2015.
Application No. 14/544,787 is a continuation-in-part of application No. 14/120,871, filed on Jul. 7, 2014.
Application No. 14/120,871 is a continuation-in-part of application No. 13/999,599, filed on Mar. 11, 2014.
Application No. 13/999,599 is a continuation-in-part of application No. 13/694,028, filed on Oct. 22, 2012, now Pat. No. 8,733,012.

(51) Int. Cl. A01K 85/18; A01K 95/00; A01K 83/00; A01K 91/04

(52) U.S. Cl. CPC A01K 85/18; A01K 91/04; A01K 95/00; A01K 83/00

(57) ABSTRACT

An angled frame, bladed weighted novel fishing lure is disclosed in which the blade is designed to oscillate side-to-side during retrieval and is loosely, but securely affixed to an angled frame which enhances extraordinarily enhances hook and hook assembly motion. The frame includes an inferior portion that is connected to a lure stabilizing weighted body and hook receiver and includes forwardly disposed features for attachment of a blade and fishing line.

### CONTINUITY

This application is a Continuation-in-Part of U.S. patent application Ser. No. 14/545,547, titled INLINE BLADED FISHING LURE and filed May 19, 2015; which is a Continuation-in-Part of U.S. patent application Ser. No. 14/544,787, titled FRAMES FOR BLADED AND WEIGHTED FISHING LURES and filed Feb. 18, 2015; which is a Continuation-in-Part of U.S. patent application Ser. No. 14/120,871, titled BLADED FISHING LURE and filed on Jul. 7, 2014; which is a Continuation-in-Part of patent application Ser. No. 13/999,599 titled LURE FISHING ASSEMBLY WITH WEIGHTED FRAME and filed Mar. 5, 2014; which is a Continuation of patent application Ser. No. 13/694,028, titled LURE FISHING ASSEMBLY WITH WEIGHTED FRAME and filed Oct. 22, 2012, now allowed as U.S. Pat. No. 8,733,012; which is a Continuation-in-Part of U.S. patent application Ser. No. 13/200,900, titled INTERCHANGEABLE BLADE AND LURE FISHING ASSEMBLY and filed Oct. 4, 2011, now allowed as U.S. Pat. No. 8,739,460; which is a Continuation-in-Part of U.S. patent application Ser. No. 12/387,024 titled BLADED FISHING LURE ASSEMBLY and filed Apr. 27, 2009, now allowed as U.S. Pat. No. 8,973,298; which is a Continuation-in-Part of U.S. patent application Ser. No. 11/656,099, titled FISHING LURE ASSEMBLY and filed Jan. 22, 2007, now abandoned, which are made part hereof by reference.

### BACKGROUND

1. Field of Invention

This invention relates generally to weighted, oscillating bladed fishing lures, and more particularly to fishing lures that exhibit an angled frame construction between a fishing line connection on the forward end and the hook connection on the rearward end where a hook is attached to create an enhanced and surprising bait action.

2. Related Art

There are many types of lures designed to attract fish. A fishing lure line connector is disclosed in U.S. Patent Application US 2013/0219770 by Inventor, James Ronald Davis (Davis). Davis discloses a fishing line connector having a single width and having a unitary elongated member shaped to form first and second eyelets at each member end. The line connector may be connected to a blade.

A snag-less fishing lure is disclosed in U.S. Patent Application US 2013/0047491 by Inventor, James Ronald Davis (Davis). Davis discloses a snag-less bladed lure having a blade that oscillates during retrieval and pitches forward to protect the hook from snagging upon encountering moss or other elements in the water. The fishing lure may include pitching means for pitching the blade relative to the hook. Further, the upper end of the blade oscillates side-to-side relative to a hook connector.

A snag resistant fishing lure is disclosed in U.S. Pat. No. 7,726,062 B2, issued Jun. 1, 2010 to James Ronald Davis (Davis). Davis discloses a jig with an attached blade. The jig has a weight molded about the shank of a hook with an eyelet disposed to maintain the sharpened point of a hook held upright by the relative dispositions of the eyelet, weight and orientation of the point. The blade is taught to be affixed to the eyelet, and to be limited in oscillation by either collision of the blade with the eyelet or with the weight to which it is directly affixed. Further, the blade is taught to comprise three holes, one of which is used to securely affix the blade to the eyelet. The other two holes are taught to be used in cooperation with a clip affixed to a fishing line for the purpose of releasably affixing the fishing line of a fishing lure unit which comprises both blade and weighted fishing lure.

Wuensch et al., U.S. Pat. No. 8,028,465 B1, teaches a fishing lure and method of assembly comprising a lip, an eyelet extending forward of the lip. The eyelet being adapted to be attached to the fishing line for pulling the fishing lure through the water in a direction of movement towards the lip such that the lip imparts a movement to the fishing lure. Additionally, a buoyant or neutrally buoyant paddle extending from, and rigidly attached to the lip, having opposed side surfaces that together counterbalance the movement imparted by the lip. The invention includes a hook having a shank that is fixedly attached to and extends from the paddle.

Applicant believes that no fishing lure reference, disclosed, is the basis for an angled frame that increases the range of hook or hook assembly lateral side-to-side motion.

### Definitions

For purposes of this disclosure, the following definitions apply:

aft, adv, near, toward, or in the rear of a lure away from a line of attachment.

angle of attach, n, and angle at which a blade is disposed relative to horizontal (or vertical) angle as the blade is displaced through water.

blade, n, a broad flattened part which is affixed to a portion of a fishing lure and which oscillates as the lure is propelled in water to provide a wake following therefrom; such a blade may be rigid or flexible, if flexible such a blade requires a supporting mast to withstand pressure from being displaced through water; in the instant invention the blade is considered to be affixed to a frame in a manner which results in frame motion directly resulting from blade motion.

centrally, adv, near, toward the center of gravity, syn: medially.

distal, adj, (see also proximal) indicates the segment of a device normally away from a line attachment of a lure.

fishhook, n, a device, usually made of rigid metal wire, comprising at least one curved section and ending with a sharpened point on each curved section for catching a fish and a shank which comprises a substantially straight portion on an opposite end. Generally, the shank is ultimately affixed with an eyelet (hook connector feature) and split ring to the lure or it may be directly and securely affixed to the hook receiver portion of the lure.

fishhook assembly, n, a combination of a fishhook and other optional attributes associated with the fishhook for attaching the fishhook to a frame or frame and for adding attractive components such as an artificial or natural bait.

fore, adv, in, toward or adjacent to the front (i.e. forward) toward a line of attachment.

inferior, adj, situated lower down or closer to the center of the earth than a referenced site.

jig, n, a fishhook which has a weight affixed about an associated shank of the fishhook

proximal, adj, indicates the segment of a device normally closely disposed relative to a line attachment of a lure.

shank, n, a frame which is a proximal portion of a fishhook the shank usually having a substantially straight portion which is associated with a curved portion of a fishhook and with a connecting link by which the fishhook is affixed to other fishing gear.

substantially, adv,: having a similar form and function which does not materially depart from an ideal or perfect form of the referenced item (e.g. a ball may be considered to be substantially spherical while having minor variances which cause it to be imperfect relative to an ideal sphere).

superior, adj, situated higher up or away from the center of the earth relative to a referenced site.

yaw, n: oscillatory angular motion which is disposed about an axis subtending substantially orthogonally behind a blade of a lure.

vertical oscillation: oscillatory angular displacement which is substantially disposed about an axis determined by oscillation about an angle of attack of a blade.

### BRIEF SUMMARY AND OBJECTS OF THE INVENTION

Various fish species are particularly attracted to lures that exhibit extreme side-to-side motion during retrieval. In brief summary, this invention is based upon a novel fishing lure frame in combination with an oscillating blade and a strategically disposed weight for a bladed fishing lure assembly. The frame comprises an angled construction which forms connections for a fishing line and a trailing fishhook or fishhook assembly to specifically enhance lateral side-to-side lure action increasing fish attraction to the lure.

An associated bladed fishing lure assembly comprises the blade, a weight and a fishhook or fishhook assembly affixed to the frame. The frame includes a feature for connecting a fishing line at a forward end and a rearwardly disposed portion whereat the weight is affixed such that frame motion influences subsequent motion of the weight and associated fishhook or fishhook assembly. The frame comprises a plurality of bends and may include a member to provide support where about the blade oscillates in a first oscillating mode. The angle of the blade as it is drawn through water is also influenced by the weight positioned rearward of the blade. Other factors may affect blade angle of attack such as buoyancy of the bait.

The blade is positioned forward relative to the weight such that when drawn through the water, the blade yaws or oscillates and rotates side-to-side in a second oscillating mode. The blade is securely, but loosely affixed to the frame by at least one frame member which is disposed through a blade opening (in the case of a blade slot) or blade openings (in the case of suitably sized holes in the blade). The blade opening or openings are sized such that blade oscillation is communicated to the frame. While oscillating in the second mode, the blade thus communicates force which results in rotary oscillatory frame displacement.

The frame further comprises a following member which distends aft of the blade and which is downwardly distended by mass of an attached weight in surrounding water to thereby provide lure stability. One additional bend in the following member provides a succeeding member which provides a site for connecting the fishhook or fishhook assembly. The additional bend and succeeding member perform two functions. First, the additional bend tunes following lure parts to a predetermined plane of lure action. Second, the additional bend provides a lever arm (of the succeeding member) whereby action of the second mode of oscillation is communicated to the frame and therefrom to a fishing lure assembly. In addition, blade oscillation in the first mode yields turbulent flow aft of the blade which may be communicated to the weight and following fishing lure assembly to enhance lure action.

The frame may include a loosely affixed fishhook or fishhook assembly rearward of the weight and may include a split ring or other suitable connector or the fishhook may be attached directly to the frame hook receiver. The fishhook may be a treble, single barbed or other suitable hook. The frame may also include a clasp or ring whereby the blade is securely, but loosely affixed thereto. The blade may be manufactured of metal or plastic or other suitable material that oscillates when drawn through water according to the invention. An angled frame construction between the fishing line connection and fishhook or fishhook assembly exaggerates the side-to-side hook or hook assembly motion. This enhancement results in a broader side-to-side hook and/or hook assembly action presenting a novel and desirable lure for attracting fish.

Lures made according to the instant invention may have as few as four components and include novel frame features for ease of assembly with minimal threading when assembled to a blade designed for oscillation when drawn through water. A weight may be attached to the frame between a line connection feature and a fishhook or fishhook assembly which is located at the rearward end of the bladed fishing lure. The weight may also be affixed to the frame fore or aft of the additional bend and may be securely or loosely affixed to the frame.

The frame may include a single jointed segment to provide immediate feedback when a fish strikes the hook. The lure having a distinctive angled character of the additional bend may in certain instances require tuning from time to time by the user to re-form the frame back to its desired shape after use when forces applied change the frame bend angle to an extent that lure action is reduced. Such a frame may be made from spring tempered stainless steel wire, stamped steel or brass, or other suitable material that allows for assembly of lure components and generally maintains an enhanced lateral side-to-side lure action.

In summary, primary to the invention is the interaction of an oscillating blade and the frame to create an enhanced lateral side-to-side motion in hook and hook assembly. The loosely, but securely attached oscillating blade, comes in contact with the frame and having sufficient mass creates a “hammer” effect during each oscillation, the resulting energy of contact is transferred through the frame that is securely attached to the weight to create a laterally opposing side-to-side which is transferred to the hook or hook assembly.

It is a primary object to provide a substantially angled frame and bladed fishing lure assembly having a frame shaped to facilitate ease of blade assembly.

It is another primary object is to provide a bladed fishing lure having an enhanced bait motion relative to the motion of the weight.

Another object is to provide a frame that moves directly in relation to the side-to-side movement of the oscillating blade.

An important object is to provide a hooking capability attached rearward of the weight which can be accomplished with a looped fishhook receiver, split ring or other hook connector directly attached to a frame fishhook receiver.

It is an important object to provide a blade member that is securely, but pivotally affixed to the frame such that the blade oscillates when displaced through water.

It is a major object to provide a simplified method for connecting a blade to a frame and for amplified displacement of a fishhook or fishhook assembly due to the oscillation of the blade.

These and other objects and features of the present invention will be apparent from the detailed description taken with reference to accompanying drawings.

### BRIEF DESCRIPTION OF THE DRAWINGS

FIG. 1 is a rearward perspective of the weighted lure components having a straight frame prior to assembly of lure components except the blade which is shown in the assembled position.

FIG. 2 is a rearward perspective of the weighted lure assembly with a weight and spacer or sleeve assembled on the frame. The hook is unassembled on the lure assembly.

FIG. 3 is a rearward perspective of the weighted fishing lure with an angled frame having a crimped sleeve for add support for maintaining the frame angle which amplifies hook and bait action

FIG. 3A is a partial section of the lure assembly seen in FIG. 3 with a weight disposed aft of a support sleeve disposed about a part of the frame and disposed to maintain a tuning angle of the weighted lure.

FIG. 4 is a frontal elevation of the weighted lure assembly showing the oscillating blade in dashed lines and the front frame clip assembled to hold the blade on the frame.

FIG. 5 is a rearward perspective of the weighted fishing lure with an angled frame without a crimped sleeve. A sharp bend in the frame rearward of the weighted body maintains the weighted body in position forward of the hook assembly receiver.

FIG. 6 is a rearward perspective of the fishing lure with the angled frame having a clasp at the rearward frame tag end and showing other weighted lure components when drawn through water.

FIG. 7 is a rearward perspective of the weighted fishing lure with the blade having only one hole and positioned prior to assembly to the frame and including a forward frame geometry shaped for placement through the blade.

FIG. 8 is a rearward perspective view of the weighted fishing lure having a hardened wire form frame forward of the weighted body and a stainless spring steel wire form frame at the distal end of the weighted lure assembly.

FIG. 9 is a forward perspective of the weighted fishing lure assembly with the frame constructed of stamped steel and a ring or split ring positioned forward of the blade to maintain the blade to the frame.

FIG. 10 is a side elevation of the weighted fishing lure showing the geometry of the stamped steel frame as it supports the rearward side of the blade.

FIG. 11 is a top elevation (Prior Art) of the weighted fishing lure having a straight frame and with the lure motion noted in dashed lines as drawn through water to demonstrate the fishhook and fishhook assembly motion.

FIG. 12 is a top elevation of the weighted fishing lure having an angled frame with enhanced lure motion noted in dashed lines.

FIG. 13 is a side elevation of the weighted fishing lure having an angled frame with internal components noted in dashed lines.

FIG. 13A is a magnified, more detailed cross section of the circled portion of the frame seen in FIG. 13.

These and other objects and features of the present invention will be apparent from the detailed description taken with reference to accompanying drawings.

### DETAILED DESCRIPTION OF THE ILLUSTRATED EMBODIMENTS

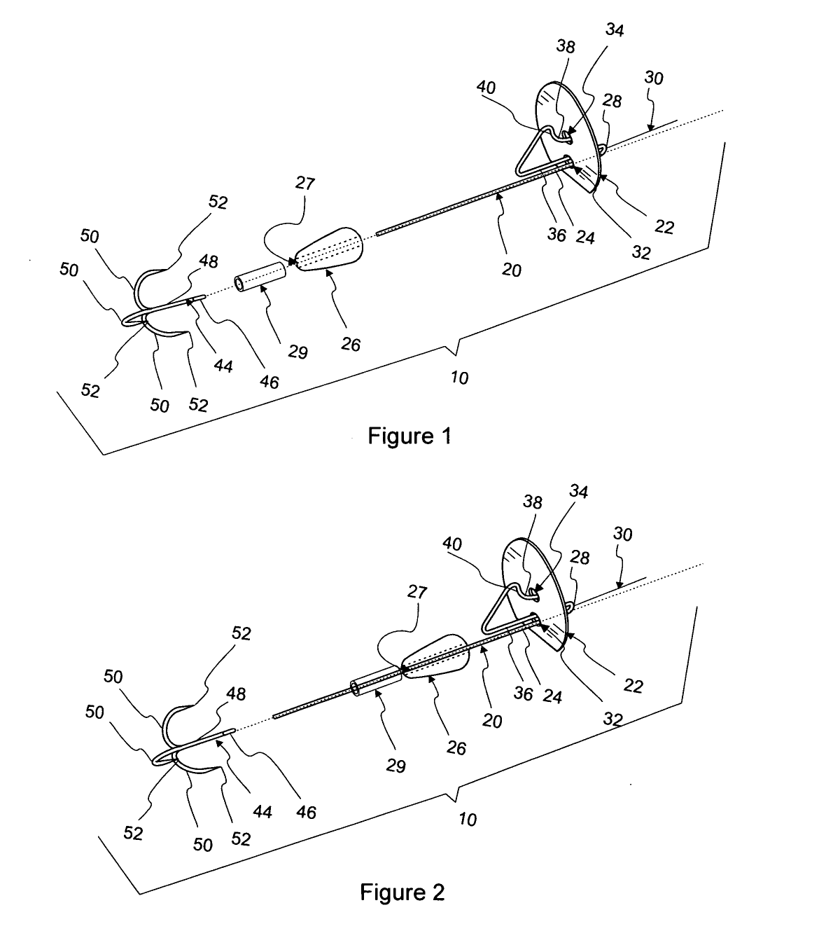

Reference is now made to the embodiments illustrated in FIG. 1-13A. In the following description, primes of number designate labeled lure parts which are similar to form and function, but not identical, to parts numbered without primes.

Reference is now made to FIG. 1, wherein an inline bladed fishing lure assembly 10 made according to the instant invention is seen and is currently the preferred embodiment having an exploded view of components. Assembly 10 comprises a frame 20 which may be manufactured using stainless steel tempered wire. Frame 20 has an attached blade 22 that is loosely, but securely affixed to frame 20 such that it oscillates when drawn through water. Blade 22 may be made of materials such as stainless steel, brass, plastic or other suitable materials that oscillate about a frame when drawn through water. Assembly 10 also comprises an inferiorly directed, substantially straight, frame segment 24 to which a weight 26 and sleeve 29 is slidably, but securely affixed. Weight 26 also includes an inner lumen 27, indicated by dashed lines (commonly numbered 27) disposed about segment 24. Weight 26 may be made of metal such as lead alloy, tungsten, brass, and tin that provide a ballast for assembly 10. Other metals may also be used in forming weight 26 that have sufficient mass to act as ballast for assembly 10. Frame 20 further comprises a forward bend 28 for attaching a fishing line (denoted by number 30) 30. Blade 22 comprises a medially disposed inferior hole 32 through which segment 24 is displaced.

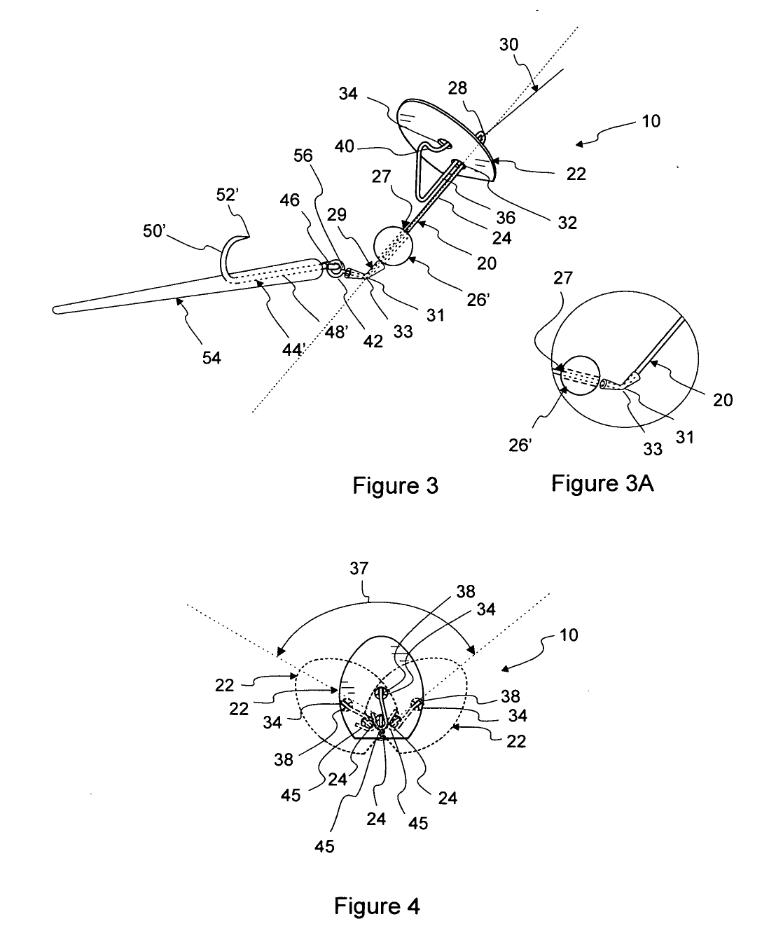

A frame segment 38 passes through a superior hole 34 of blade 22. Frame 20 may have a superiorly directed segment 40 rearward of blade 22 for orienting blade 22 for oscillation when drawn through water. Frame segments 38 and 24 are sized and shaped to have contact points through blade holes 34 and 32 respectively, for orienting blade 22 for oscillation when displaced relative to water. Inferiorly directed frame segment 24 is disposed to pass through weight 26 and sleeve 29 to be formed into a rearward fishhook receiver 42 (see FIG. 3) for securing fishhook assembly 44 and fishhook connector 46 to frame 20. In the example seen in FIG. 1, fishhook assembly 44 also includes a shank 48 and three fishhook bends, each commonly numbered 50, with each fishhook bend terminating in sharpened end 52.

Reference is now made to FIG. 2, wherein a partially assembled bladed fishing lure assembly 10 is seen to have an initially manufactured straight section of frame 20 for slidably attaching weight 26 and sleeve 29 which is used for positioning weight 26 on frame 20. Weight 26 acts as the ballast for oscillating blade 22. Fishhook 44 has a shank 48 and a plurality of fishhook bends (commonly numbered 50) each terminating in a hook sharpened point 52. The fishing lure may be manufactured in various sizes, colors and weights to meet the requirements of catching a variety of fish.

Reference is made again to FIG. 3, wherein bladed fishing lure assembly 10 is shown assembled and which is the preferred embodiment. A tuning frame bend 31 is placed in frame 20 rearward of blade 22. This frame bend 31 creates an off axis angle generally between 30 degrees and 60 degrees depending upon the weight and buoyancy created, in the example seen in FIG. 3, by the bait 54.

It should be noted that the angle of bend 31 is used to dispose hook assembly 44 in a desired operating plane when displaced relative to water. A crimp 33 in sleeve 29 assists to maintain frame bend 31. The effects of frame bend 31 on lure action are described in FIG. 12. Fishhook assembly receiver 42 may have tag end 56 wrapped about frame 20 rearward of weight 26′ (which is differently shaped than weight 26, seen in FIG. 1) to secure fishhook 44′. Fish hook 44′ may have an attached bait (examples of which are bait 54, live or other artificial soft or hard bait). Of note, bend 31 and sleeve 29 with crimp 33 may be positioned forward of weight 26′ (not shown).

Reference is now made to FIG. 4 wherein blade 22 is shown as it oscillates from side to side (dashed lines) and noted by angled arrowed line 37. Also shown is a frame clasp 45 which is clasped rearward of frame bend 28 (See FIG. 1) and inferior to segment 24 such that blade 22 remains affixed to frame 20.

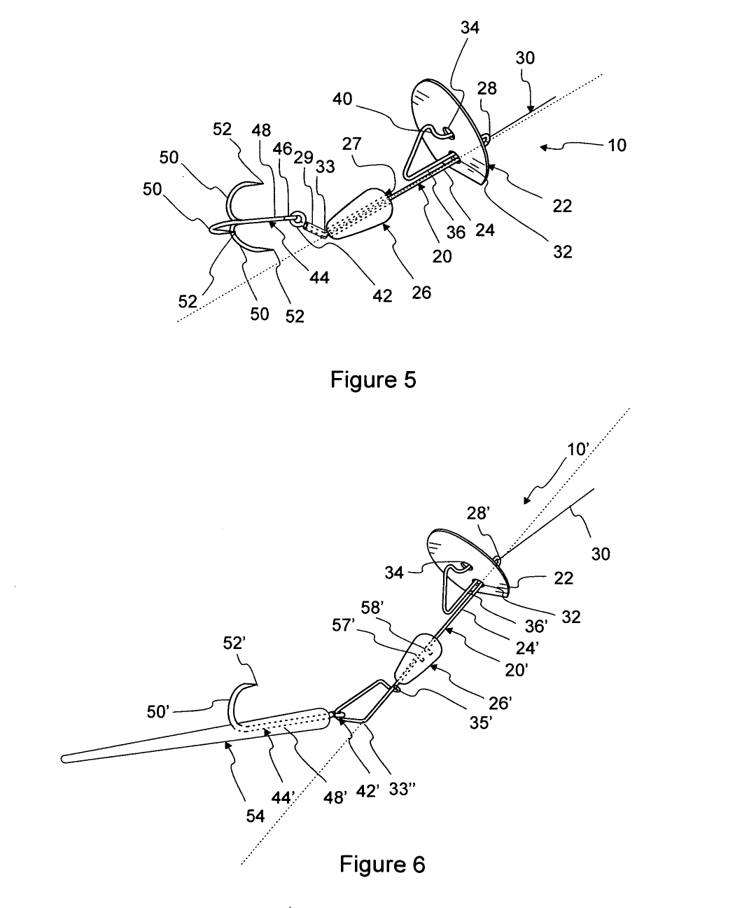

Reference is now made to FIG. 5 wherein the weighted blade fishing lure 10 is shown with sleeve 29 uncrimped on frame 20. One skilled in the art will understand that a wire form frame 20 at bend 33 may straighten as forces such as created by large fish are experienced. Anglers may easily reset bend 33 back to the manufactured angle using pliers.

Referring to FIG. 6, a bladed fishing lure assembly 10′ is shown with frame 20′ having a rearward structure associated with a clasp 35 allowing the user to change fishhook assembly 44′ to varying fishhook styles (not shown) for attaching a bait 54 assembly. Wire clasps, such as clasp 72′, are well known to those skilled in the art. Bladed fishing lure assembly 10′ may be manufactured with a single wire form, however single wire forms may become interconnected during manufacture and be difficult to separate. For this reason, it may be considered prudent to manufacture a second, separate wire form for affixing bladed fishing lure assembly (such as fishhook 44′) rearward of weight 26′. In the case where two wire forms are utilized, wire form bends 57′ and 58′ demonstrate how each may be held securely within weight 26′.

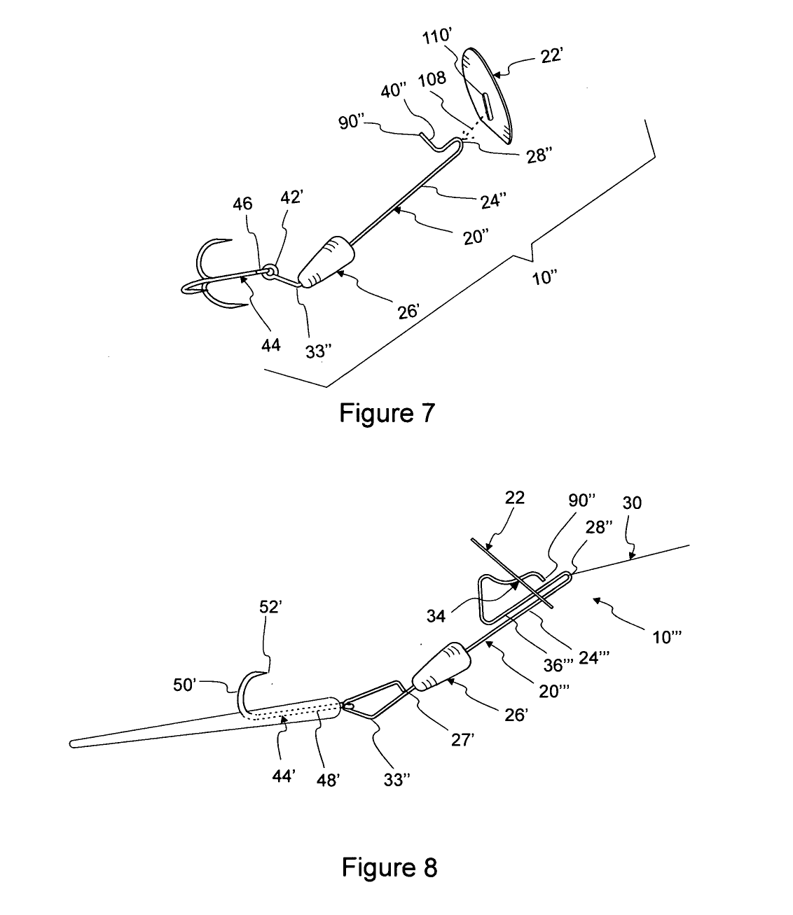

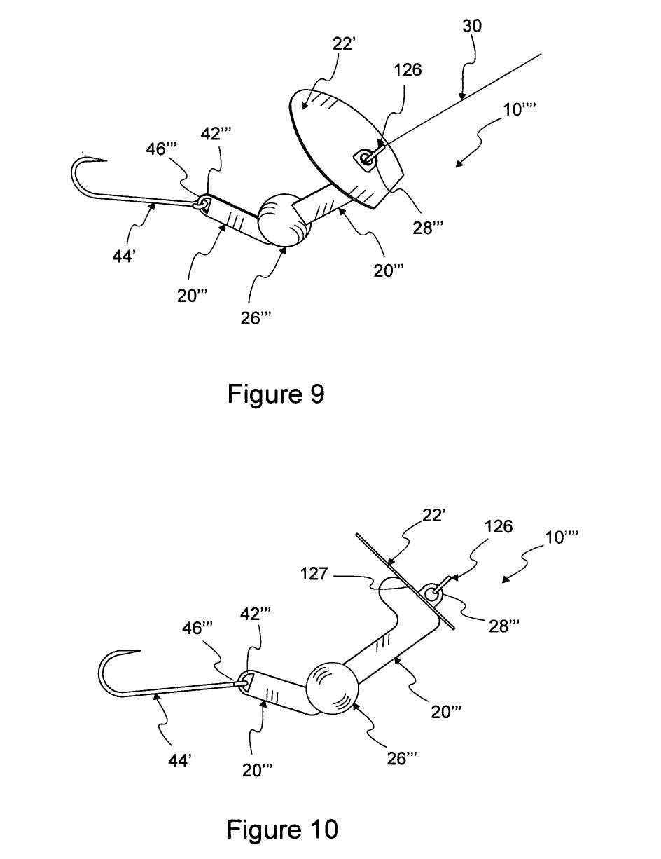

FIG. 7 shows a simplified frame 20″ having a frame bend 28″ and a superior extending mast 40″ ending in a tag end 90″ which is attached to blade 22′ through a single blade slot 110′ as indicated by dashed line 108. Blade 22 is held in place using a split ring or other retaining member (See FIG. 9). Extending mast 40″ supports blade 22′ during oscillation through water. Frame 20″ may be manufactured of tempered stainless steel or hardened wire. One who is skilled in the art will understand in the case of hardened wire, the weight is molded directly to frame 20 and hook connector 46 requires an initial state where there is an open hook connector 46 loop which is then closed about hook receiver 42.

Reference is now made to FIG. 8 wherein frame 20′″ is manufactured of wire such as hardened wire similar to that used in fishhooks to generally retain their shape, although not hardened to the extent that minor bends are impractical in lure construction. Blade 22 is attached to frame 20′″ in a similar manner as in FIG. 1. Frame bend 28″ is placed through inferior blade hole 32 first and then a tag end 90″ is inserted through superior blade hole 34 and is then bent inferiorly to loosely, but securely attach blade 22 to frame 20′″. Frame 20′″ has an angled bend 33″ rearward of weight 26′. Frame 20″ has a tag end 27′ that is bent inferiorly after hook assembly 44′ is assembled to frame 20″.

Reference is now made to FIG. 9 wherein is shown a stamped metal frame 20′″ having a forward line connector 28′″ and associated line connector ring 126 for maintaining blade 22′ on frame 20′″. Line connector ring 126 may be a simple ring, split ring, clip or other component that maintains the blade on frame 20′″.

Reference is now made to FIG. 10. Stamped frame 20′″ has an edge 127 that provides contact with blade 22′ to set blade 22′ angle of attack.

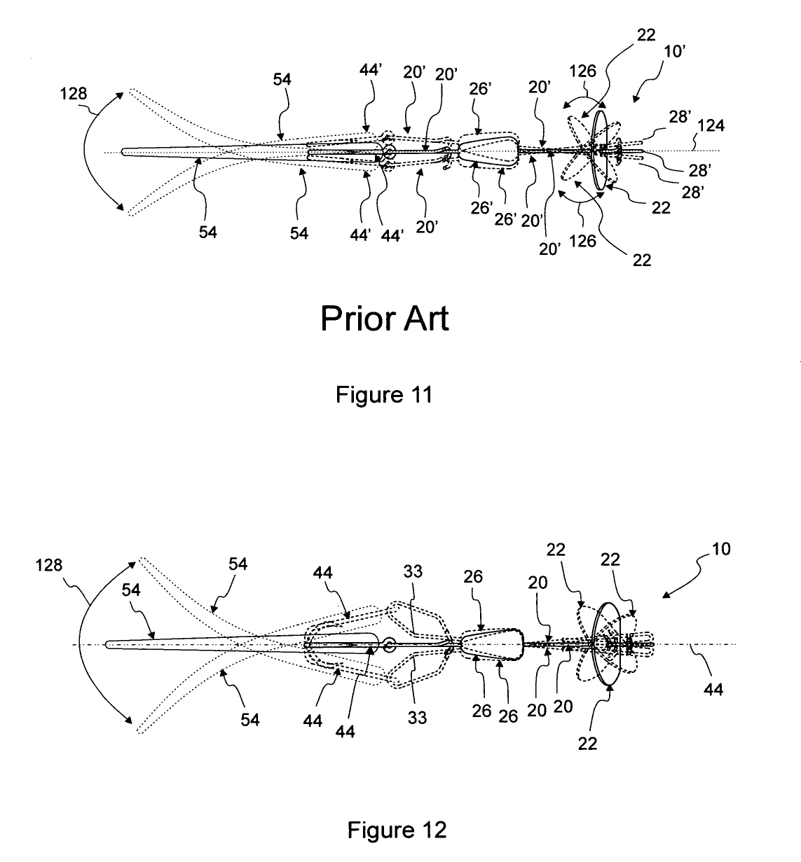

Reference is now made to FIGS. 11 and 12. In FIG. 11, the instant invention is shown in a top view and is identified as Prior Art relating to an inline frame 20′. Angular motion as referenced by arrowed line 128 produces side-to-side displacement which is linearly communicated to rear lure parts. Blade 22 rotation as noted by arrowed line 126 and resulting contact with frame 20′ produces bladed fishing lure angular rotation with fishhook 44′ angled to influence bait 54 motion when drawn through water. FIG. 12 shows an angled bend 33″ in frame 20 resulting in greater bait 54 lateral motion as noted by arrowed arched line 128. It is the magnitude of this bend, and related bends in frames associated with the instant invention, that provides amplified motion to the lure.

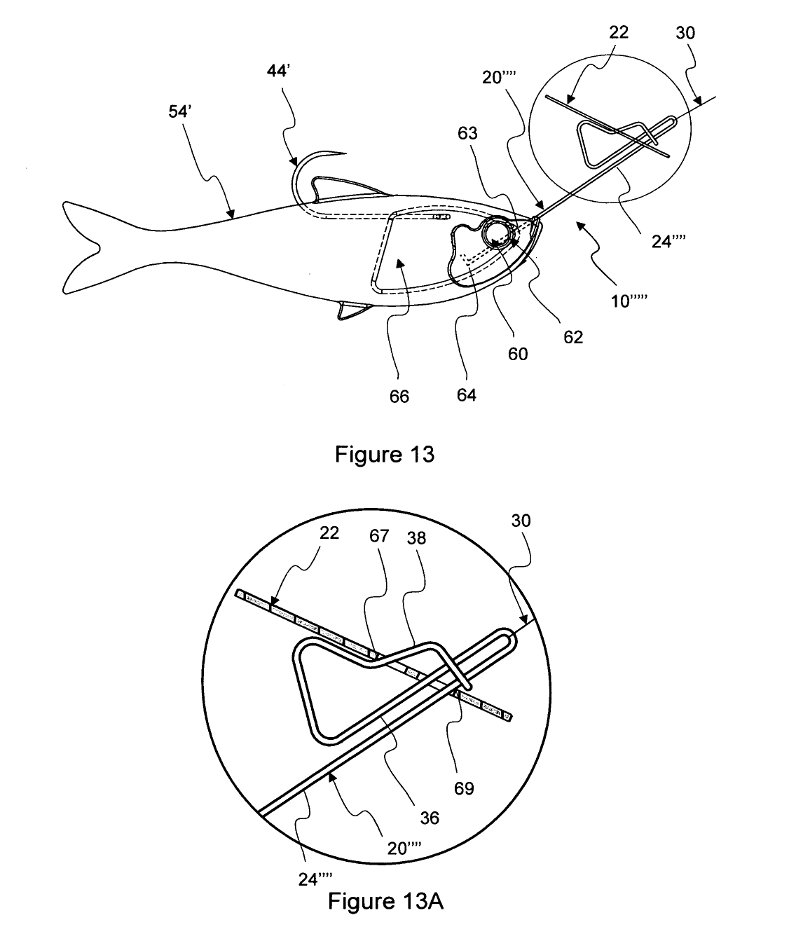

Reference is now made to FIGS. 13 and 13A. In FIG. 13, the instant invention is shown as a fishing lure 10″″′ with various internal components shown in dashed lines. A weight 66 is molded about frame 20″″. Hook connector 64 is molded securely into weight 66 with an angle of lure orientation determined by angles of that disposed by weight 66 relative to section 24″″ of frame 20″″. In the embodiment shown, bait 54′ has a cut-out orifice 62 and weight 66 has a molded eye 60 which protrudes from orifice 62 although such molded eye 60 and cut out 62 are not necessary for the lure to function and the lure may be formed without such features. Eye 60 may be a part of a weight 66 which is securely affixed to frame 10″″′. A tuning bend, which is primary to the instant invention, may be formed in combination by the entry point of frame 20″″ into weight 66 making weight 66 part of the frame with the angled frame portion identified in the drawing as intersection 63. The combination provides the novel bait action for lures made according to the instant invention where oscillating blade 22 drives lateral motion of weight 66 and associated bait 54′. Frame bend 64 maintains frame 20″″ securely fastened to weight 66. FIG. 13A shows magnified section detail of a clasp which securely affixes blade 22 to frame 20″″. Blade 22 has a superior blade hole contact site 67 and an inferior blade contact site 69. Bait 54′ may be manufactured with artificial materials such as plasticized vinyl or other soft materials as well as polycarbonate or other suitable hard plastic material.

The present embodiment should be considered in all respects as illustrative and not restrictive, the scope of the invention being indicated by the appended claims rather than by the forgoing description, and all changes which come within the meaning and range of equivalency of the claims are therefore intended to be embraced herein.

What is claimed and desired to be secured by Letters of Patent is:

1. A bladed fishing lure frame comprising an angular bend which creates an offset to enhance lateral side-to-side fishing lure motion, said frame comprising:
(1) a superior segment and an inferior segment extending separately through a blade having two associated blade holes dimensioned for allowing the blade to fit loosely relative to the superior and inferior segments and each of said superior and inferior segments having a blade hole contact site to determine blade angle of attack;
(2) a first blade retaining member aft of said blade holes and a second blade retaining member forward of said blade holes to maintain the blade loosely, but securely affixed to the frame for oscillation when drawn through water;,
(3) a line connection loop forward of said blade for affixing a fishing line;
(4) a substantially straight section aft of the fishing line connecting site and blade,
(5) a site for a weight to be securely affixed rearward of the blade and forward of a fishhook or fishhook assembly receiver to provide ballast for an associated fishing lure;
(6) said angular frame bend formed rearward of the blade and forward of the hook receiver for creating enhanced side-to-side motion of the frame and fishhook assembly when drawn through water resulting from blade oscillation; and
(7) said fishhook receiver providing a connection site for the fishhook assembly.

2. A bladed fishing lure according to claim 1 comprising a weight securely attached to a rearward section of the frame, said weight having an angled geometry which defines plane of motion of an associated fishing lure assembly and extending rearward a desired distance to enhance lateral side-to-side motion of the fishhook assembly.

3. A bladed fishing lure according to claim 1 comprising a frame comprising a single continuous wire.

4. A bladed fishing lure according to claim 1 comprising a frame comprising two wire parts linearly joined by a securely affixed weight.

5. A bladed fishing lure according to claim 1 comprising a blade comprising two holes whereby the blade is affixed to the frame and one of the two holes through which a section is displaced to communicate with the weight and fishhook attachment site.

6. A bladed fishing lure according to claim 1 comprising a weight further comprising an elongated frustoconical shape with an aft disposed diminished dimension.

7. A bladed fishing lure according to claim 1 comprising a weight comprising shape and dimensions of a fish.

8. A bladed fishing lure according to claim 1 comprising a frame comprising a plurality of bends whereby buoyancy of an associated fishhook assembly causes the associated fishhook assembly to be resultingly displaced upward into improved communication with turbulence associated with wake of said blade when free of pulling force upon an associated fishhook assembly.

9. A bladed fishing lure according to claim 1 comprising an associated fishhook comprising a single treble hook.

10. A bladed fishing lure according to claim 1 comprising a fishhook assembly to frame connection comprising a releasable clasp.

11. A bladed fishing lure according to claim 1 comprising a frame comprising blade affixing segments which comprise a releasable clasp.

12. A bladed fishing lure according to claim 1 comprising an affixed fishhook assembly comprising a fishhook and bait.

13. A bladed fishing lure comprising a frame comprising a plurality of bends and associated frame members between said bends comprising:
said frame, an associated blade which is loosely affixed to said frame and which oscillates when water is displaced thereabout, a weight affixed to said frame which is disposed to stabilize the lure in water and a fishhook assembly;
said members comprising at least one member which is disposed relative said blade to provide medially directed support about which the blade oscillates at a predetermined angle of attack in a first mode when affected by water being displaced about the blade to produce a turbulent wake there from;
said blade comprising at least one opening for being loosely but securely affixed to said frame forward of said weight such that the blade yaws and oscillates from side-to-side is a second oscillating mode as affected by water being displaced about the blade;
said frame comprising at least one member disposed through said at least one opening and said at least one member and said at least one opening comprising cooperative structure such that blade second mode oscillation is forcibly communicated to the frame;
a following member disposed aft of said blade which provides a communicating pathway to said weight, said following member comprising a tuning bend whereby a succeeding member aft of the following member provides a directional correction to lure parts affixed thereafter;
the succeeding member comprising a connecting segment whereby said fishhook assembly is affixed to the frame to be dynamically affected by the motion of the blade; and
said connecting segment comprising a predetermined length and angle by which second mode oscillatory motion is magnified thru said tuning bend and communicated to said fishhook assembly.

14. A bladed fishing lure according to claim 13 wherein said opening comprises two holes, one for each member of a frame comprising two members which are displaced therethrough.

15. A bladed fishing lure according to claim 13 wherein said weight is affixed aft of said tuning bend.

16. A bladed fishing lure according to claim 13 wherein said weight is securely affixed to said frame.

17. A bladed fishing lure according to claim 13 wherein said fishing lure assembly comprises a single fishing hook.

18. A bladed fishing lure according to claim 13 wherein said frame comprises a support sleeve about said tuning bend for maintaining a tuned lure state.

19. A bladed fishing lure according to claim 13 wherein said tuning bend comprises and angle between 30 and 60 degrees.

20. A bladed fishing lure according to claim 13 wherein said weight comprises an integral, visible part of said fishhook assembly.
